(19) United States
(12) Patent Application Publication
(10) Pub. No.: US 2003/0132387 A1
(43) Pub. Date: Jul. 17, 2003

(54) Method and device for measuring the amount of coating on a moving substrate

(75) Inventors: Jussi Tenhunen, Oulunsalo (FI); Markku Kansakoski, Oulu (FI); Markku Mantyla, Kangasala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation OY

(21) Appl. No.: 10/282,944

(22) Filed: Oct. 29, 2002

Related U.S. Application Data
(63) Continuation-in-part of application No. 09/622,115, filed on Aug. 11, 2000.
Application No. 09/622,115 is a 371 of international application No. PCT/FI99/00098, filed on Feb. 10, 1999.

(30) Foreign Application Priority Data
Feb. 12, 1998 (FI) 980323

(51) Int. Cl. G01N 21/35

(52) U.S. Cl. 250/339.11

(57) ABSTRACT

The invention relates to a method and a device for measuring the amount of coating on a moving substrate. Reflection measurement is used in the invention for measuring the properties of a coating. The amount of calcium carbonate in the coating is measured by measuring an absorption peak of calcium carbonate at a wavelength of about 3.95 micrometers and/or the amount of kaolin is measured by measuring an absorption peak of kaolin at a wavelength of about 2.7 micrometers.

### CROSS-REFERENCE TO RELATED APPLICATIONS

This application is a continuation-in-part of U.S. application Ser. No. 09/622,115, which is a national phase application of International Application No. PCT/FI99/00098, filed Feb. 10, 1999, both of which are incorporated by reference herein in their entirety.

### FIELD OF THE INVENTION

The invention relates to a method for measuring the amount of coating on a moving substrate, the method comprising measuring the amount of at least one component in a coating by reflection measurement.

The invention also relates to a device for measuring the amount of coating on a moving substrate, the device comprising a radiation source for producing a light beam, a detector for measuring the reflected light beam and means for processing a signal of the detector, the device being arranged to measure the amount of at least one component in a coating.

### BACKGROUND OF THE INVENTION

In a manufacturing process it is important to monitor the amount of coating on a moving substrate, such as paper or cardboard web. Coating improves the printing quality of paper, and the amount of coating should, if possible, be kept constant in one paper grade. The coating materials consist of binders and coating pigments. The most common coating pigments used in coating are kaolin, calcium carbonate and titanium dioxide. During a paper manufacturing process the amount of coating is in general continuously measured by measuring devices moving in cross direction of the paper perpendicularly over the paper web as the web moves forward.

U.S. Pat. No. 5,455,422 describes a method in which the amount of coating is measured by measuring, for example, the absorption peak of latex at a wavelength of 2.30 micrometers and the absorption peak of clay at a wavelength of 2.21 micrometers. Said patent further describes the measurement of calcium carbonate by measuring the amount of backscattering at a wavelength of 2.09 micrometers. However, for measuring the amount of calcium carbonate said method is unreliable and inaccurate, since the method is based on a weak cellulose absorption coverage effect caused by the coating and dependent on multiple factors and not on the absorption caused by carbonate. The amount of calcium carbonate could also be determined, for example, on the basis of kaolin measurement assuming that the ratio between the amounts of kaolin and calcium carbonate in a coating is constant. However, this is not always the case, and problems are created particularly if the kaolin content is low i.e. below approximately 20% and the carbonate content correspondingly high i.e. approximately 80%.

EP publication 0 332 018 shows a method in which the amount of kaolin in paper is measured by transmission measurement, for example, at wavelengths of about 1.4 and 2.2 micrometers. However, by transmission measurement the portion of coating in the measurement result is very difficult to determine. Furthermore, the portion of calcium carbonate has to be approximated as shown in the previous chapter.

GB publication 2 127 541 shows how transmission measurement is used for measuring the amount of additives in paper. The publication describes how the amount of calcium carbonate is measured by measuring the absorption peaks at wavelengths of 11.54 micrometers and 11.77 micrometers. The amount of coating cannot be measured by said method, since the fillers in base paper are included in the results. Furthermore, the absorption of paper can be so high that measurement through paper is not possible. Moreover, in its entirety, the accuracy of the measurement results is not good enough.

It is an object of the present invention to provide a method in which the above drawbacks can be avoided.

### SUMMARY OF THE INVENTION

The method of the invention is characterized by measuring the amount of calcium carbonate by measuring an absorption peak of calcium carbonate at a wavelength of about 3.95 micrometers.

The device of the invention is further characterized by being arranged to measure the amount of calcium carbonate in the coating by measuring an absorption peak of calcium carbonate at a wavelength of about 3.95 micrometers.

The essential idea of the invention is to measure the amount of at least one component of the coating by reflection measurement so as to measure the amount of calcium carbonate by measuring the absorption peak of calcium carbonate at a wavelength of about 3.95 micrometers and by measuring a reference value for the measurement of the absorption peak of calcium carbonate at both a greater wavelength and a lesser wavelength than the calcium carbonate measuring wavelength. The invention has the advantage that the amount of calcium carbonate can be measured accurately and reliably. In one embodiment, the amount of calcium carbonate is measured and the amount of kaolin is measured at a lower wavelength than the calcium carbonate measuring wavelength. Also, water content is measured at a first wavelength near the calcium carbonate measuring wavelength and at a second wavelength near the kaolin measuring wavelength. Further, separate reference measurements are made for calcium carbonate near the calcium carbonate measuring wavelength, for kaolin near the kaolin measuring wavelength, and for moisture content near both the first and second wavelengths. It is possible to measure the total amount of calcium carbonate and kaolin from several applications on top of one another. The selectivity of the measurement for both calcium carbonate and kaolin is very good.

### BRIEF DESCRIPTION OF THE DRAWINGS

In the following, the invention will be described in greater detail in the accompanying drawings, in which:

FIG. 1 is a schematic view showing a measuring device of the invention;

FIG. 2 shows spectra of base paper and paper coated with calcium carbonate;

FIG. 3 shows spectra of base paper and paper coated with kaolin; and

FIG. 4 shows spectra of base paper and paper coated with calcium carbonate and with baseline correction.

### DETAILED DESCRIPTION OF THE PREFERRED EMBODIMENTS

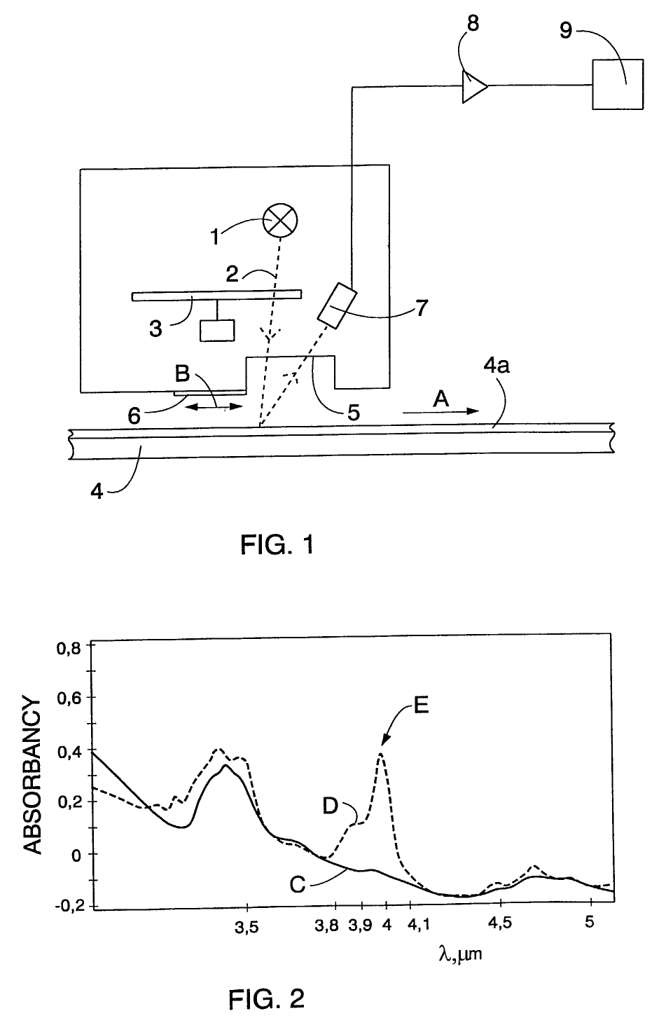

FIG. 1 shows a measuring arrangement where radiation reflected from an object is measured, i.e. the radiation source and the receiver are on the same side of the object to be measured. Said measurement is referred to as reflection measurement.

FIG. 1 shows a measuring device comprising a radiation source 1 producing a light beam 2. The radiation source 1 may be, for example, a halogen lamp or another suitable radiation source for producing an infrared beam. The light beam 2 is directed through a filter 3. The filter 3 filters the light so that only the light that is essential for the measurement and that is at the right wavelength band enters the measurement point. The filter 3 may be, for example, a rotating filter disc including several interference filters or another filter solution known per se. The structure of the filter 3 is as such known for those skilled in the art, and is therefore not explained in greater detail in this context. After the filter 3 the light beam 2 is directed through a window 5 to a paper or cardboard web 4 moving in the paper machine. The window 5 can be made of quartz glass or sapphire, for example. The paper or cardboard web 4 moves in the direction of arrow A. A coating 4a is arranged on the surface of the paper or cardboard web 4. Instead of the moving paper or cardboard web 4, the moving substrate, the coatings of which are measured, may also be, for example, a roll of a paper coating machine, a roll of a paper machine and/or generally a surface of a metal plate. The device also comprises a reference sample 6 which is moved at given intervals to the measurement point as indicated by arrow B. The sample 6 operates as a reflection reference and the measurement result obtained therefrom provides a picture of the condition of the light source 1, the detector 7 and the window 5. In addition, reference measurement can, if desired, be used to correct the actual measurement result.

The reflected light beam 2 is directed to a detector 7. From the detector 7 the signals are directed through a preamplifier 8 to a computer 9 for processing the measured data in a manner known per se. For the sake of clarity, FIG. 1 does not show the optics possibly needed to direct the light beam 2. The structure used for conducting/guiding the light may be, for example, visualizing optics, an optical fiber or a bundle of optical fibers.

In FIG. 2, curve C shows a reflection spectrum of base paper and curve D, indicated by a dashed line, shows the reflection spectrum of paper coated with calcium carbonate. The wavelength λ in micrometers is on the horizontal axis and the absorbency is on the vertical axis. When the spectra were measured, an absorption peak E was unexpectedly found for calcium carbonate at a wavelength range of 3.95 micrometers. By arranging the device according to FIG. 1 to measure the absorption peak at a wavelength of about 3.95 micrometers, the device can measure the amount of calcium carbonate.

For the measurements, a base line correction is need and thus at least one measurement on a reference wavelength is needed. Details of the reference measurement(s) are discussed further herein in more detail. It should be noted that any reference wavelengths close to the actual measurement peak can be used as a reference wavelength. What is essential is that the absorbencies of base paper or coated paper are equal or nearly equal at said wavelength range.

Scattering is dependent on wavelength and thus increased scattering on any optical surface, such as in the coating or in base paper, results in a relative change of the system transmission which will not be equal at the coating component measurement wavelength and the reference wavelength. In addition, the absorption coefficient of the base paper is wavelength dependent and, accordingly, the reference wavelength cannot be selected where the absorption coefficient will be equal for the measurement wavelength and the reference wavelength. By measuring a reference value for the measurement of the absorption peak of the measured component both at a greater wavelength and a lesser wavelength than the measured component measuring wavelength, and thereby implementing a so-called two point base line correction method, the above mentioned problems can be avoided. The reference wavelengths should be selected in proximity to the absorption peak of the coating component. At the time of measurement, two reference wavelengths are selected, one on either side of the measurement wavelength. The two measuring results are then used to determine the more accurate reference value as interpolated for the measurement channel wavelength. The coating weight is then determined from the difference between the measurement wavelength and the determined reference value. The two point base line correction method thus eliminates most of the residual error due to the wavelength dependence of scattering and the base paper absorption.

Suitable reference wavelengths for measuring calcium carbonate are, for example, 4.55 micrometers and/or 3.7 micrometers. When the reference wavelengths for measuring calcium carbonate are 4.55 micrometers and 3.7 micrometers, it means that the reference value for the measurement of the absorption peak of calcium carbonate is measured both at a greater wavelength and a lesser wavelength than the calcium carbonate measuring wavelength 3.95 micrometers. The wavelength 3.7 micrometers is particularly advantageous, since it can also be used as a reference wavelength for measuring the amount of water.

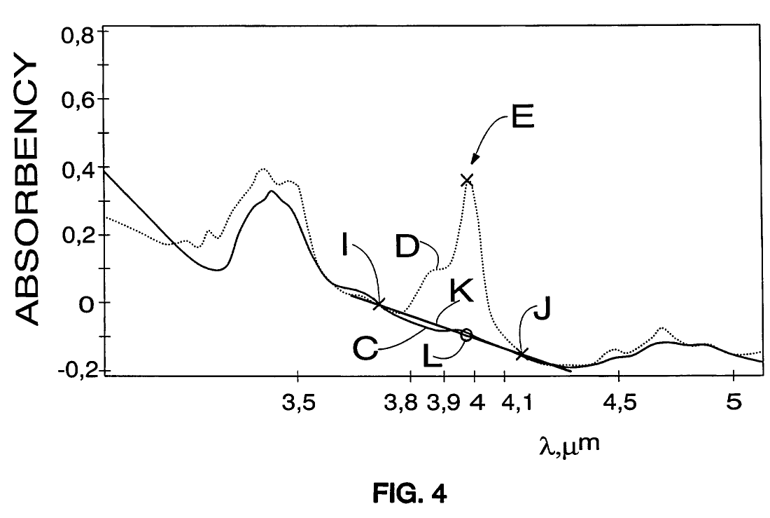

Also, as for measuring calcium carbonate reference wavelengths, 3.75 micrometers and 4.15 micrometers can be used as shown in FIG. 4. Thus, the reference measurements are performed from both sides of the point where calcium carbonate is sensitive to absorption. From the reference measurements I and J, an estimate L of the radiation strength level outside the absorption peak can be formed. The estimate L is formed by interpolating the radiation strength at the reference measurement wavelengths. Thus, the estimate L is insensitive to the absorption of calcium carbonate and it takes into account a possible change of the base line K in different measurements. The base line K corresponds to the line segment combining points I, L and J in FIG. 4. A very accurate measurement concerning the absorption strength at the wave length 3.95 micrometers is obtained when a difference is formed between the absorption peals E and the estimate L.

The measurements performed show that the reflectivity increases in the range over 6.3 micrometers, when the basis weight of carbonate was increased. But in the range under 6.3 micrometers the reflectivity decreases, when the basis weight of carbonate was increased, the absorption measurement thus functioning reliably in this range.

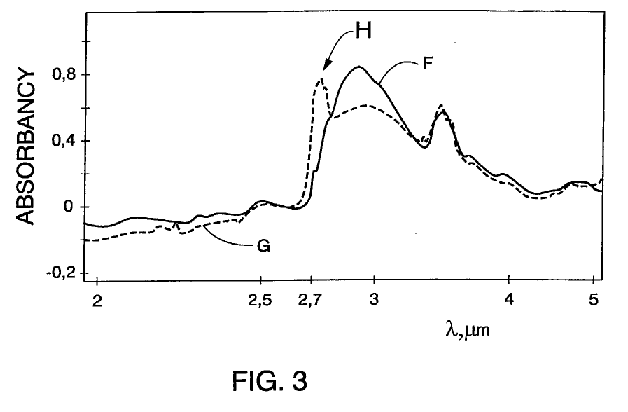

In FIG. 3, curve F shows the reflection spectrum of base paper and curve G, indicated by a dashed line, shows the reflection spectrum of kaolin coated paper. FIG. 3 also shows the wavelength λ in micrometers on the horizontal axis and the absorbency on the vertical axis. When the spectra were measured, an absorption peak H was unexpectedly found for kaolin at a wavelength range of about 2.7 micrometers. By arranging the device according to FIG. 1 to measure the absorption peak at a wavelength of about 2.7 micrometers, the amount of kaolin in the coating can be determined. Also, for measuring kaolin, at least one measurement on a reference wavelength is needed. Suitable reference wavelengths for kaolin are, for example, 2.64 micrometers and/or 2.8 micrometers. Kaolin can also be measured, for example, at a wavelength of about 2.2 micrometers. More specifically, kaolin can be measured at a wavelength of 2.208 micrometers. The reference wavelengths for measuring the amount of kaolin are then preferably 2.125 micrometers and 2.231 micrometers.

As for the properties affecting the signal-to-noise ratio of the radiation source, the windows and the detectors and the price of the device, a measurement wavelength of 3.95 micrometers is advantageous for measuring the amount of calcium carbonate. Furthermore, the measurement of the amount of carbonate at a wavelength range of 3.95 micrometers can be implemented in the same sensor as the measurement of the absorption peak of kaolin at 2.7 micrometers or about 2.2 micrometers.

When measuring the coating of the paper web, the response of the component to be measured is proportional to the basis weight of the component—that means the amount of the component—and to the moisture of the component. Thus by measuring the amount of water—that means the moisture content—the measurement of the amount of the component can be specified. It is advantageous to measure the moisture content for different coating components at different wavelengths. Also for water measurements the base line correction is needed, and thus at least one reference measurement is necessary.

When measuring the amount of calcium carbonate, the moisture content is preferably measured at a wavelength that is close to the measurement wavelength of calcium carbonate of 3.95 micrometers. The amount of water can be measured e.g. at a wavelength of 3.25 micrometers. Then the reference wavelength for measuring water content could be 3.5 micrometers. Because cellulose has a considerably strong and wide absorption peak at a wavelength range of under 3.25 micrometers, it has been found that the absorption peak of cellulose hides the absorption peak of water at certain wavelengths and thus a two point base line correction method cannot be applied at this point. In tests, it has been found that one reference wavelength for base line correction is enough in this instance.

The penetration of a measuring beam is lower at a lower wavelength. Therefore, it is preferable to measure the amount of water separately for a kaolin measurement since the specific absorption peak for kaolin is at a lower wavelength than the absorption peak of calcium carbonate. If kaolin is measured at 2.2 micrometers, the amount of water is preferably measured at a wavelength of 1.94 micrometers. The reference wavelengths for measuring the amount of water are then preferably 1.8 micrometers and 2.3 micrometers. The absorption peak of water at the wavelength of 1.94 micrometers is small and clear and cellulose does not have an absorption near this wavelength. Therefore, the use of the two point base line correction method is preferable at this point.

It is preferable to make the base line correction for all different measured components. That means a separate reference measurement is preferably made for calcium carbonate measurement, kaolin measurement, and moisture content measurement.

The drawing and the description associated thereto are merely intended to illustrate the idea of the invention. As for the details the invention may vary within the scope of the appended claims.

That which is claimed:

1. A method for measuring the amount of coating on a moving substrate, the method comprising:
measuring the amount of at least one component in a coating by reflection measurement;
wherein said reflection measuring step comprises measuring the amount of calcium carbonate by measuring an absorption peak of calcium carbonate at a wavelength of about 3.95 micrometers and by measuring a reference value for the measurement of the absorption peak of calcium carbonate both at a greater wavelength and a lesser wavelength than the calcium carbonate measuring wavelength.

2. A method as claimed in claim 1 wherein the moving substrate is a paper or cardboard web.

3. A method as claimed in claim 1, further comprising continuously measuring the amount of coating.

4. A method as claimed in claim 1, further comprising directing a light beam having a selected wavelength band toward the coating, the selected wavelength band being determined by a filter.

5. A method as claimed in claim 4, further comprising measuring the wavelengths of the selected wavelength band reflected from the coating with a single detector.

6. A method as claimed in claim 1, further comprising measuring the reference value for both the measurement of the absorption peak of calcium carbonate and a measurement of the absorption peak of water at the same wavelength.

7. A device for measuring the amount of coating on a moving substrate, the device comprising:
a radiation source for producing a light beam;
a detector for measuring the reflected light beam from the coating; and
a processor for processing a signal of the detector to measure the amount of calcium carbonate in the coating by measuring an absorption peak of calcium carbonate at a wavelength of about 3.95 micrometers and by measuring a reference value for the measurement of the absorption peak of calcium carbonate both at a greater wavelength and a lesser wavelength than the calcium carbonate measuring wavelength.

8. A device as claimed in claim 7 wherein the device continuously measures the amount of coating.

9. A device as claimed in claim 7 wherein the moving substrate is a paper or cardboard web.

10. A device as claimed in claim 7, further comprising a filter cooperating with the radiation source so as to direct a selected wavelength band of the light beam toward the coating.

11. A device as claimed in claim 10 wherein a single detector is provided for measuring the wavelengths of the selected wavelength band reflected from the coating.

12. A device as claimed in claim 7 wherein the processor is arranged to measure the reference value for both the measurement of the absorption peak of calcium carbonate and a measurement of the absorption peak of water at the same wavelength.

13. A method for measuring at least one component of a coating on a moving substrate, the method comprising:
measuring an amount of the at least one component by reflection measurement;
wherein said reflection measuring step comprises measuring an amount of calcium carbonate by measuring an absorption peak of calcium carbonate at a wavelength of about 3.95 micrometers, measuring a reference value for the measuring the absorption peak of calcium carbonate at both a greater wavelength and a lesser wavelength than the calcium carbonate measuring wavelength, measuring a first amount of water by measuring a first absorption peak of water at a wavelength in proximity to the calcium carbonate measurement wavelength, and measuring at least one reference value for measuring the first absorption peak of water.

14. A method as claimed in claim 13, wherein measuring the at least one reference value for measuring the first absorption peak of water further comprises measuring the at least one reference value for measuring the first absorption peak of water at a greater wavelength than the first absorption peak of water.

15. A method as claimed in claim 13, wherein measuring the first absorption peak of water further comprises measuring the first absorption peak of water at a wavelength of about at least 3.25 micrometers.

16. A method as claimed in claim 15, wherein measuring the at least one reference value for measuring the first absorption peak of water further comprises measuring the at least one reference value for measuring the first absorption peak of water at a wavelength of about 3.5 micrometers.

17. A method as claimed in claim 13, wherein measuring a reference value for the measuring the absorption peak of calcium carbonate further comprises measuring a reference value for the measuring the absorption peak of calcium carbonate at both a wavelength of about 3.75 micrometers and a wavelength of about 4.15 micrometers.

18. A method as claimed in claim 13, further comprising measuring an amount of kaolin by measuring an absorption peak of kaolin at a wavelength less than about 3.95 micrometers and measuring a second amount of water by measuring a second absorption peak of water at a wavelength in proximity to the kaolin measurement wavelength

19. A method as claimed in claim 18, further comprising measuring a reference value for measuring the absorption peak of kaolin at both a greater wavelength and a lesser wavelength than the kaolin measuring wavelength.

20. A method as claimed in claim 18, further comprising measuring at least one reference value for measuring the second absorption peak of water.

21. A method as claimed in claim 18, wherein measuring an absorption peak of kaolin further comprises measuring an absorption peak of kaolin at a wavelength of about 2.2 micrometers

22. A method as claimed in claim 18, wherein measuring the second absorption peak of water further comprises measuring the second absorption peak of water at a wavelength of about 1.94 micrometers.

23. A method as claimed in claim 20, wherein measuring at least one reference value for measuring the second absorption peak of water further comprises measuring at least one reference value for measuring the second absorption peak of water at a wavelength of at least one of about 1.8 micrometers and about 2.3 micrometers.
